(19) United States
(12) Patent Application Publication
(10) Pub. No.: US 2004/0159695 A1
(43) Pub. Date: Aug. 19, 2004

(54) Nail stapler

(76) Inventors: Chu-Kuo Wang, Taichung Hsien (TW); Mu-Yu Chen, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/780,197

(22) Filed: Feb. 17, 2004

Related U.S. Application Data
(63) Continuation-in-part of application No. 10/227,373, filed on Aug. 23, 2002, now Pat. No. 6,742,691.

(51) Int. Cl. B25C 5/06

(52) U.S. Cl. 227/131; 173/210

(57) ABSTRACT

A nail stapler includes a magazine for containing nails and a gun for shooting the nails from the magazine. The gun includes a shell, a solenoid put in the shell, a mandrel put in the shell to be attracted from an original position to a punching position by means of the solenoid, a hammer secured to the mandrel and inserted through the solenoid, a spring for moving the mandrel to the original position from the punching position against the solenoid and a security device put in the shell for slowing down the mandrel when the mandrel is moved to the original position from the punching position by means of the spring.

### CROSS REFERENCE

The present application is a continuation-in-part application of U.S. Pat. application Ser. No. 10/227373.

### FIELD OF INVENTION

The present invention relates to a nail stapler.

### BACKGROUND OF INVENTION

Referring to FIGS. 10 and 11, a conventional nail stapler includes a gun 10 and a magazine 16. The gun 10 includes a shell 11, a solenoid 12 put in the shell 11, a mandrel 13 put in the shell 11, a spring 14 compressed between an end of the solenoid 12 and a head of the mandrel 13 and a hammer 15 secured to the mandrel 13. When activated, the solenoid 12 attracts the mandrel 13 and the hammer 15 so as to punch a staple nail 17 from the magazine 16 through an outlet 18. When the magnetic force is gone, the mandrel 13 is returned by means of the spring 14. However, the hammer 13 may hit and rebound from a portion of the shell 11 so as to punch a staple by mistake as shown in FIG. 6.

The present invention is therefore intended to obviate or at least alleviate the problems encountered in prior art.

### Summary of Invention

It is the primary objective of the present invention to provide a nail stapler with a security device for preventing stapling by mistake.

According to the present invention, a nail stapler includes a magazine for containing nails and a gun for shooting the nails from the magazine. The gun includes a shell, a solenoid put in the shell, a mandrel put in the shell to be attracted from an original position to a punching position by means of the solenoid, a hammer secured to the mandrel and inserted through the solenoid, a spring for moving the mandrel to the original position from the punching position against the solenoid and a security device put in the shell for slowing down the mandrel when the mandrel is moved to the original position from the punching position by means of the spring.

Other objects, advantages, and novel features of the invention will become more apparent from the following detailed description when taken in conjunction with the attached drawings.

### BRIEF DESCRIPTION OF DRAWINGS

The present invention will be described through detailed illustration of several embodiments referring to the drawings.

FIG. 1 is an exploded view of a nail stapler according to a first embodiment of the present invention.

FIGS. 2˜4 are cross-sectional views of the nail stapler of FIG. 1 in different positions.

FIG. 5 is a cross-sectional view of a nail stapler according to a second embodiment of the present invention.

FIG. 6 is an exploded view of a nail stapler according to a third embodiment of the present invention.

FIGS. 7 and 8 are cross-sectional views of the nail stapler of FIG. 6 in different positions.

FIG. 9 is a cross-sectional view of a nail stapler according to a fourth embodiment of the present invention.

FIG. 10 and 11 are cross-sectional views of a conventional nail stapler in different positions.

### DETAILED DESCRIPTION OF EMBODIMENTS

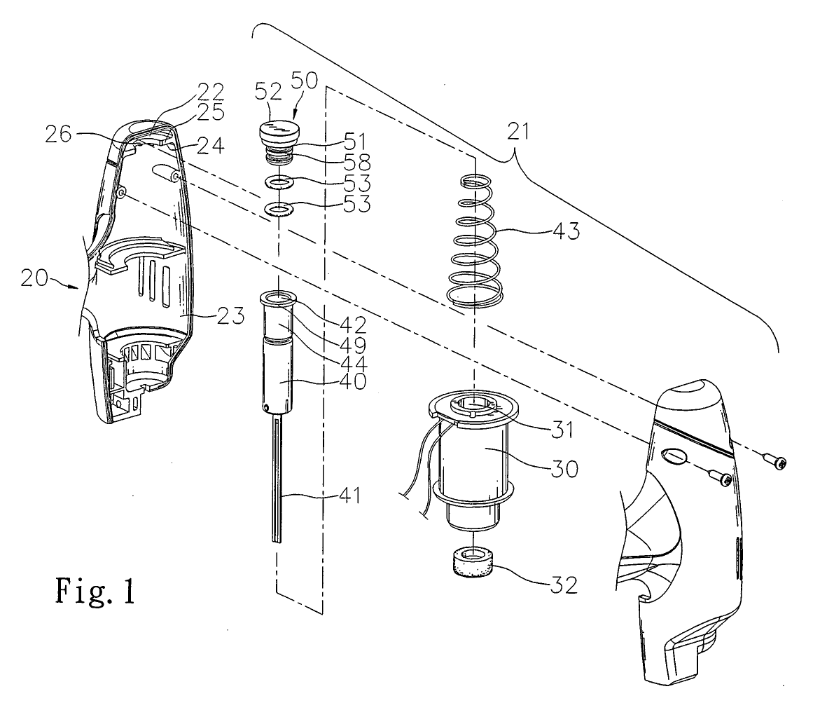

Referring to FIGS. 1-4, a nail stapler includes a gun 20 (partially shown) and a magazine 27. The gun 20 includes a shell 21, a solenoid 30 and a mandrel 40.

The shell 21 consists of two halves. A retainer 24 is formed on an internal face of each halve of the shell 21. As the halves of the shell 21 are assembled, the retainers 24 become a partition between an upper space 22 and a lower space 23. Each retainer 24 is crescent so that the retainers 24 define an aperture 26 as they are assembled.

The solenoid 30 defines an axial channel 31. The solenoid 30 is put in the shell 21. A pad 32 is positioned between the solenoid 30 and a portion of the shell 21.

A hammer 41 is secured to a lower end of the mandrel 40. The hammer 41 is inserted in the spring 43 and the axial channel 31 of the solenoid 30. The mandrel 40 is inserted in the spring 43.

A security device according to a first embodiment of the present invention is shown in FIGS. 1-4. The security device includes a cup 44 and an insert 50. The cup 44 includes an annular flange 49 formed about an upper end and a cavity 42 defined therein. The cup 44 is secured to an upper end of the mandrel 40. The spring 43 is compressed between an upper end of the solenoid 30 and the annular flange 49.

The insert 50 includes a head 52 and a body 58 extending from the head 52 and including a reduced diameter. Two rings 53 are put in two grooves 51 defined in the body 58. The insert 50 is put in the shell 21. The head 52 is put in the upper space 22 while the body 58 is put in the lower space 23 through the aperture 26 so as to retain the insert 50 in position.

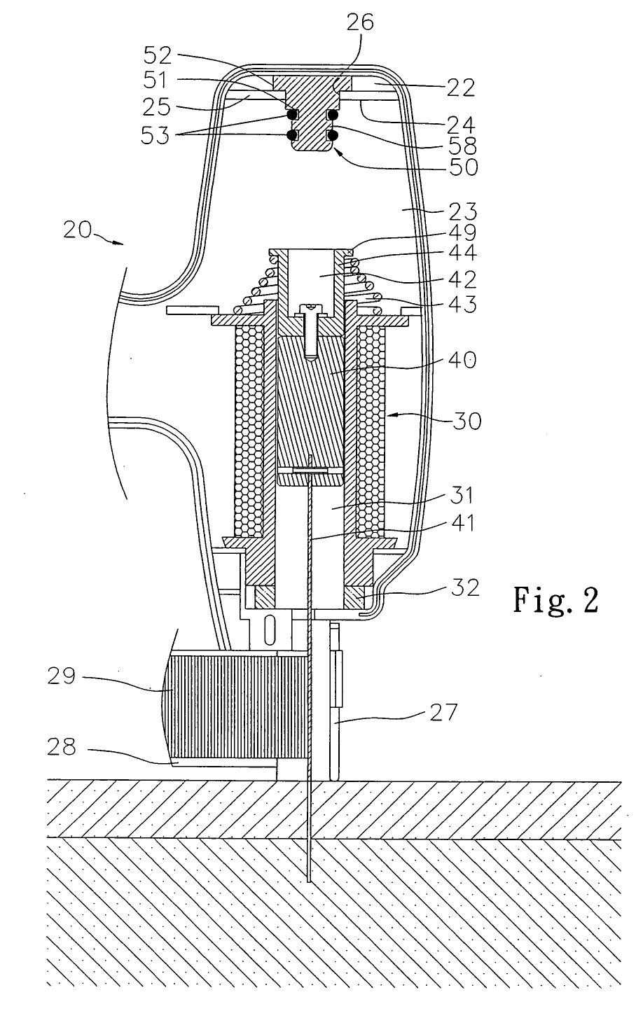

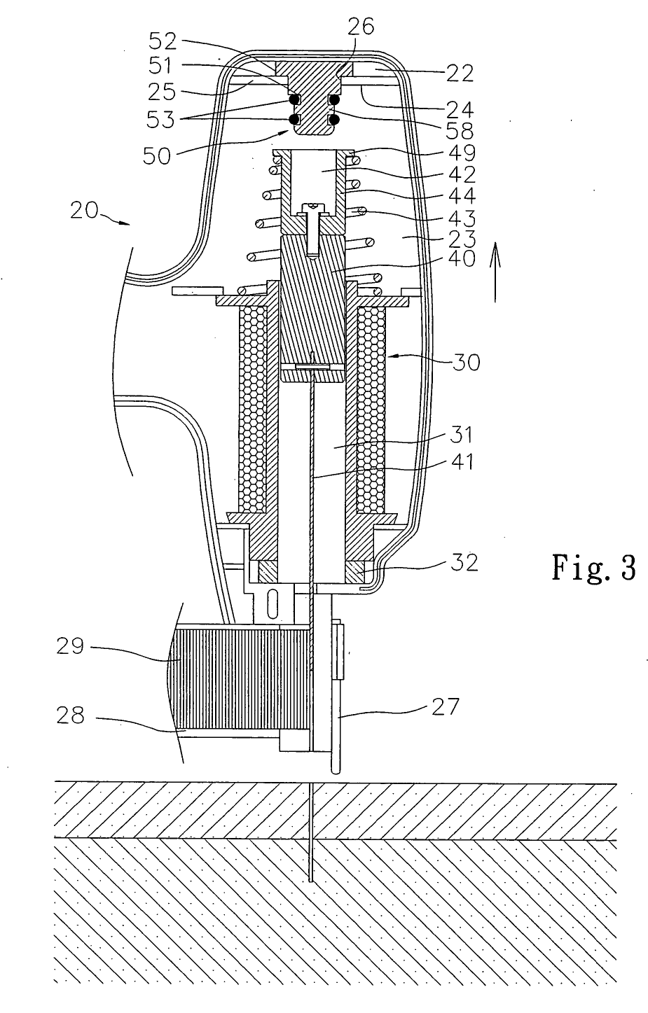

Referring to FIG. 2, when activated, the solenoid 30 attracts the mandrel 40. Therefore, the hammer 41 is moved downwards so as to punch a staple or nail 29 from a magazine 28 through an outlet 27. The spring 43 is compressed.

Referring to FIG. 3, when not actuated, the solenoid 30 releases the mandrel 40. The mandrel 40 is moved to its original position by means of the spring 43.

Referring to FIG. 4, as the mandrel 40 reaches its original portion, the rings 53 are inserted in the cavity 42. The rings 53 contact the wall of the cavity 42. Friction between the rings 53 and the wall of the cavity 42 slows down the cup 44 and therefore the mandrel 40. Thus, the mandrel 40 does not rebound from the retainer 24 and does not punch a staple or nail 29 by mistake.

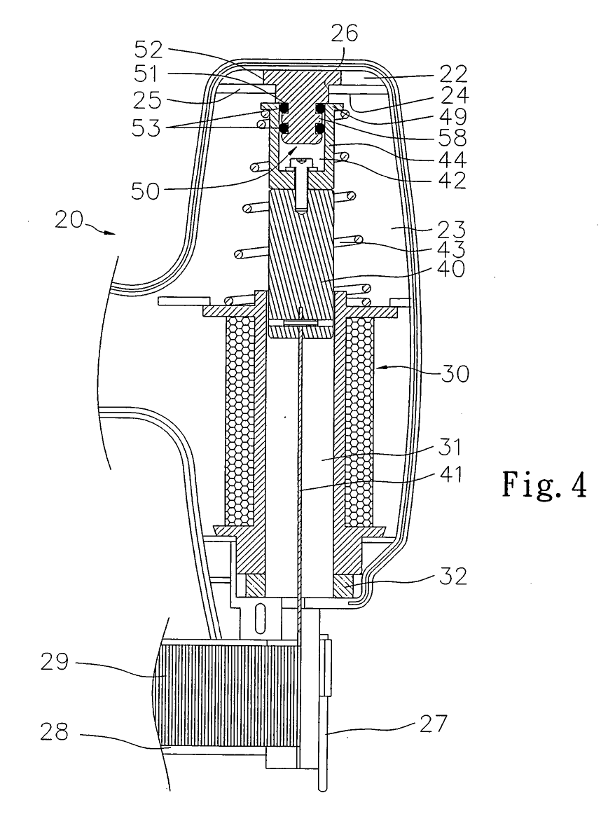

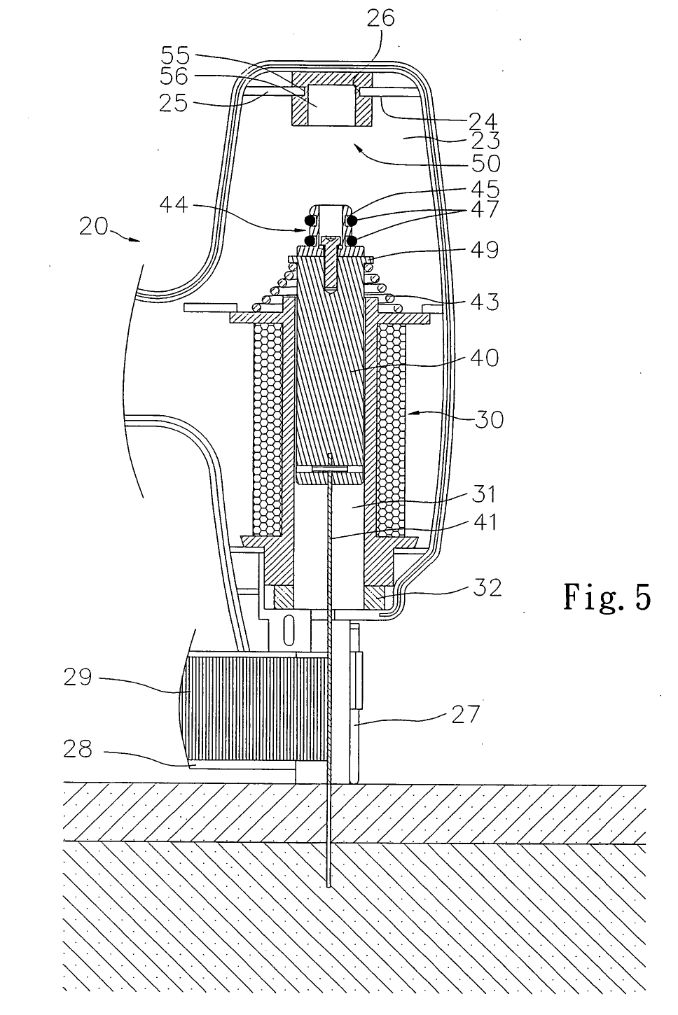

FIG. 5 shows a nails stapler according to a second embodiment of the present invention. The second embodiment is identical to the first embodiment except for including bigger and more elastic rings 54 instead of the rings 53.

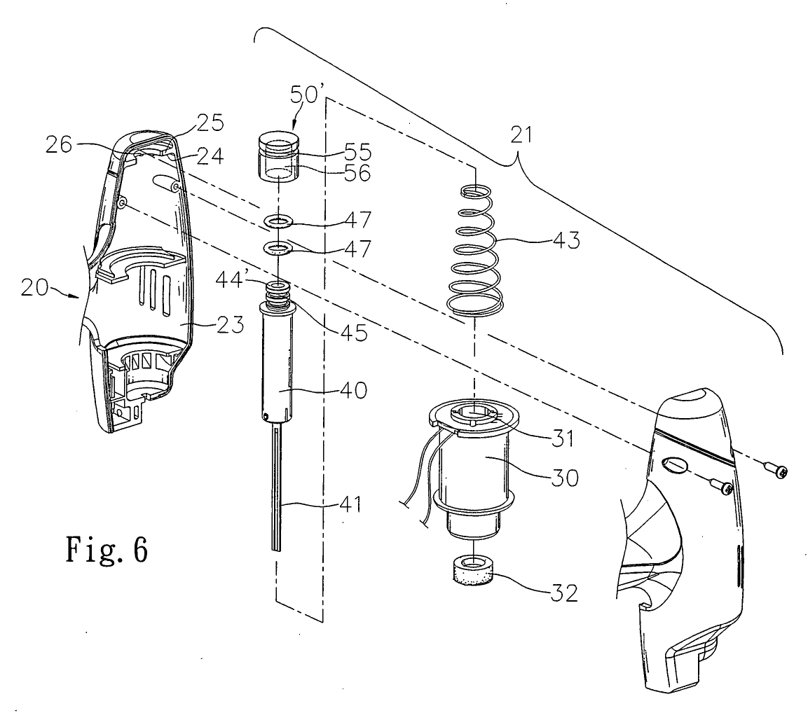

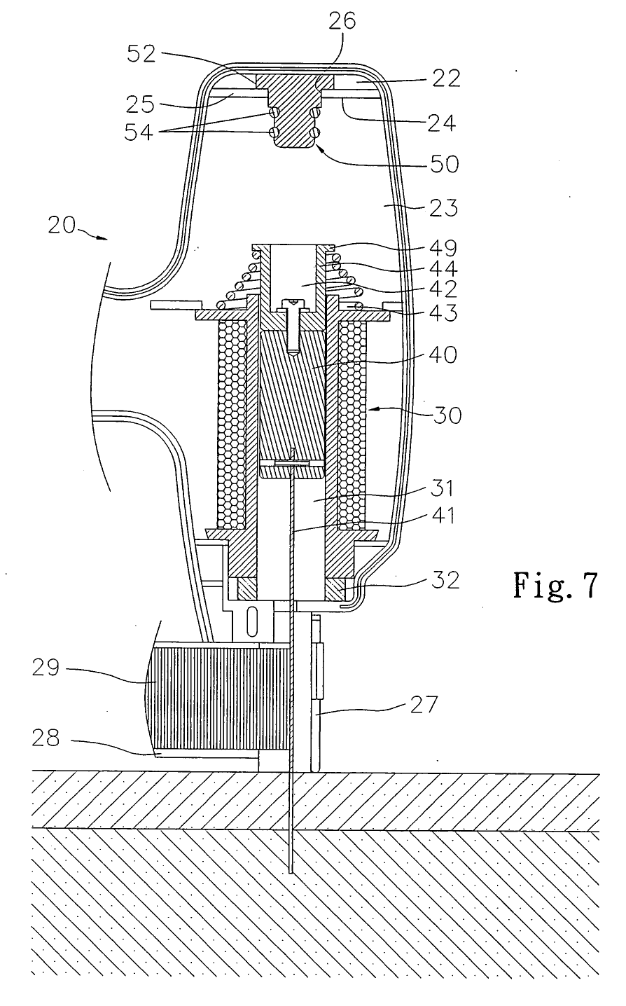

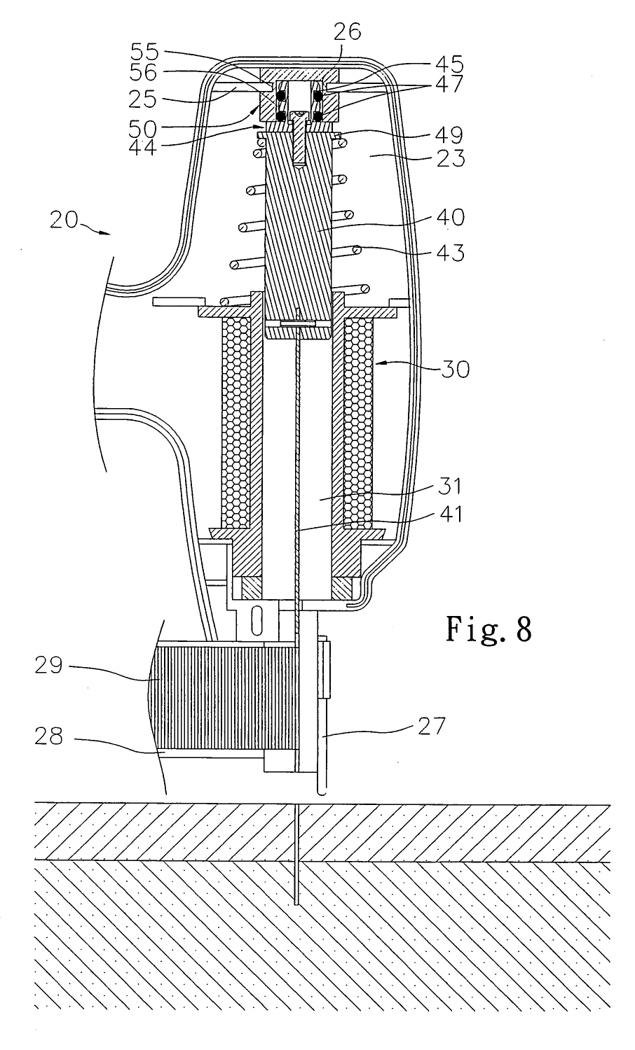

FIGS. 6-8 show a nail stapler according to a third embodiment of the present invention is shown. The third embodiment is identical to the first embodiment except for three things. Firstly, a cap 50′ is used instead of the insert 50. The cap 50′ includes an annular groove 55 defined in a periphery and a space 56 defined therein. The annular groove 55 receives the retainers 24 so as to keep the cap 50′ in position in the shell 21. The cap 50′ is like the cup 44 in function. Secondly, instead of the cup 44, an insert 44′ is secured to the mandrel 40. The insert 44′ includes two annular grooves 45 receiving two rings 47. The insert 44′ is like the insert 50 in function. Thirdly, the annular flange 49 is formed on the mandrel 40 instead of on the cup 44.

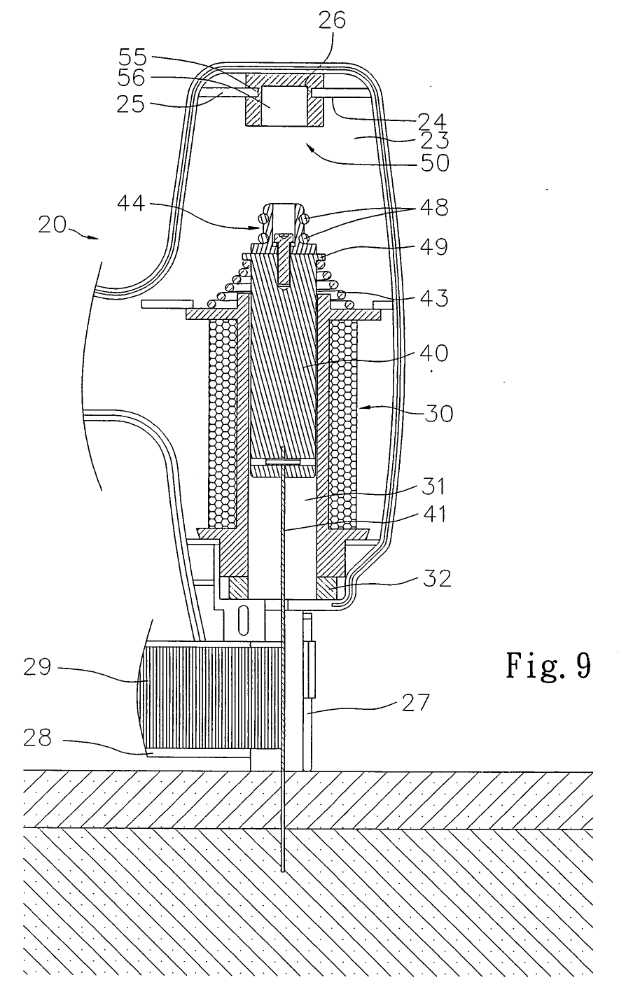

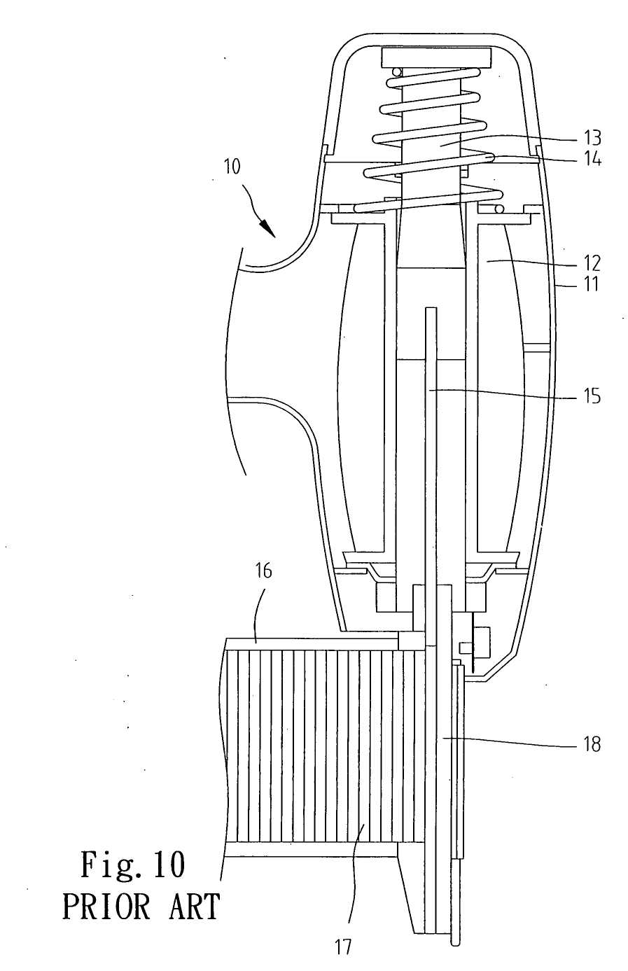

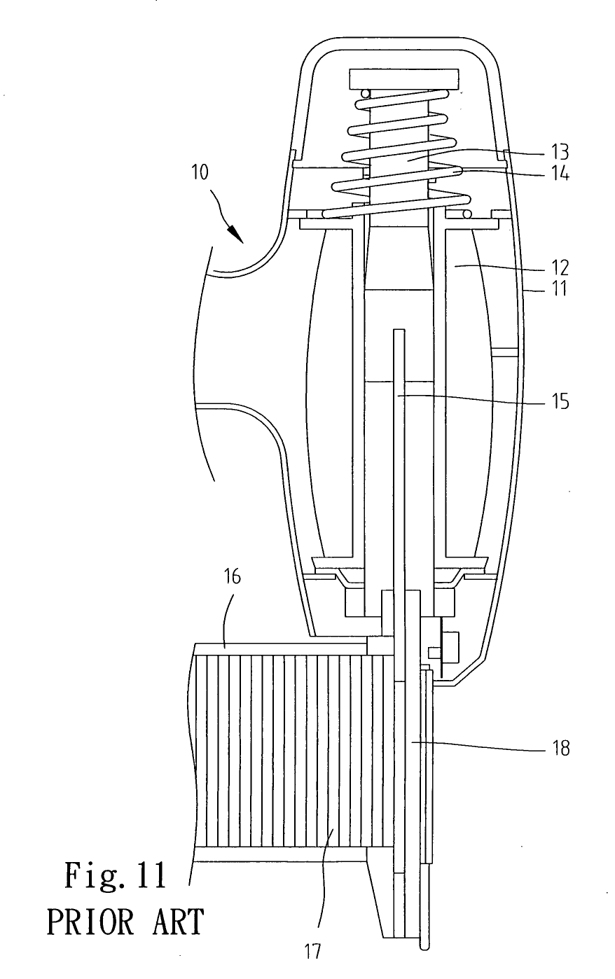

FIG. 9 shows a security device according to a fourth embodiment of the present invention. The fourth embodiment is identical to the third embodiment except for including bigger and more elastic rings 48.

The present invention has been described via detailed illustration of four embodiments. Those skilled in the art can derive variations from the embodiments without departing from the scope of the present invention. Hence, the embodiments shall not limit the scope of the present invention defined in the claims.

1. A nail stapler comprising a magazine for containing nails and a gun for shooting the nails from the magazine, the gun comprising a shell, a solenoid put in the shell, a mandrel put in the shell to be attracted from an original position to a punching position by means of the solenoid, a hammer secured to the mandrel and inserted through the solenoid, a spring for moving the mandrel to the original position from the punching position against the solenoid and a security device put in the shell for slowing down the mandrel when the mandrel is moved to the original position from the punching position by means of the spring.

2. The nail stapler according to claim 1 wherein the security device includes a cup secured to the mandrel and an insert secured to the shell for insertion in the cup with friction when the mandrel is in the original position.

3. The nail stapler according to claim 2 wherein the security device includes at least one ring attached to the insert for contact with an internal side of the cup.

4. The nail stapler according to claim 3 wherein the insert includes at least one annular groove for receiving the ring.

5. The nail stapler according to claim 3 wherein the security device includes two rings.

6. The nail stapler according to claim 5 wherein the insert includes two annular grooves for receiving the rings.

7. The nail stapler according to claim 1 wherein the security device includes an insert secured to the mandrel and a cap secured to the shell for receiving the insert with friction when the mandrel is in the original position.

8. The nail stapler according to claim 7 wherein the security device includes at least one ring attached to the insert for contact with an internal side of the cap.

9. The nail stapler according to claim 8 wherein the insert includes at least one annular groove for receiving the ring.

10. The nail stapler according to claim 8 wherein the security device includes two rings.

11. The nail stapler according to claim 10 wherein the insert includes two annular grooves for receiving the rings.
